(19) United States
(12) Patent Application Publication
(10) Pub. No.: US 2012/0269474 A1
(43) Pub. Date: Oct. 25, 2012

(54) METHOD AND DEVICE FOR SECURING AND PROTECTING A ROLLING ELEMENT BEARING

(75) Inventors: Mathias Seuberling, Grosseibstadt (DE); Reiner Wagner, Schwebheim (DE)

(73) Assignee: AKTIEBOLAGET SKF, Goteborg (SE)

(21) Appl. No.: 13/447,482

(22) Filed: Apr. 16, 2012

(30) Foreign Application Priority Data
Apr. 19, 2011 (DE) 10 2011 007 635.2
Apr. 19, 2011 (DE) 20 2011 000 921.1

(51) Int. Cl. F16C 43/04; B23P 17/00

(52) U.S. Cl. 384/560; 29/898.07

(57) ABSTRACT

A method and clamping device for securing and protecting a rolling-element bearing during a bearing mounting operation are disclosed. The rolling element bearing includes a bearing outer ring, a bearing inner ring, a bearing cage and rolling elements. The clamping device includes a clasp or fastener configured to detachably attach to an axial projection of the bearing cage. Ends of the clamping device radially extend over the bearing inner ring and bearing outer ring, respectively, so as to axially support the bearing cage relative to the bearing outer ring and the bearing inner ring when the bearing is lifted with its rotational axis extending vertically.

### CROSS-REFERENCE

This application claims priority to German patent application number 10 2011 007 635.2 filed on Apr. 19, 2011 and to German utility model application number 20 2011 000 921.1 filed on Apr. 19, 2011, the contents of both of which are fully incorporated herein by reference.

### TECHNICAL FIELD

The present invention relates to the field of rolling-element bearings, such as, e.g., toroidal, barrel, and spherical roller bearings.

### BACKGROUND

Barrel roller bearings are designed to support relatively large impulsive radial forces, but are only lightly loadable in the axial direction. They are well suited to compensate for misalignment since they are self-aligning and the outer ring can have a spherical raceway surface. The rolling elements are barrel-shaped, i.e. barrel rollers. Barrel roller bearings are single-rowed with one row of barrel rollers disposed in a bearing cage.

Spherical roller bearings are capable of supporting axial and radial loads and are also well suited to compensate for misalignments. Spherical roller bearings are self-aligning like barrel bearings, but are double-rowed. They are suitable for supporting the heaviest loads, i.e. they have high load ratings.

A CARB (Compact Aligning Roller Bearing) or toroidal roller bearing is a bearing design that combines the self-aligning ability of a spherical roller bearing with the unconstrained axial displaceability of a cylindrical roller bearing. In addition, like needle bearings, such bearings can offer the advantage of a compact design. Toroidal roller bearings generally resemble needle bearings in their external geometry, but are equipped with toroidal rollers. When utilized with correspondingly-shaped raceways, they can compensate for both axial and angular misalignment, without increasing the friction of the bearing. Thus, a toroidal roller bearing can simultaneously perform the function of a cylindrical roller bearing and a spherical roller bearing.

Toroidal roller bearings can be employed over a very large load range. They may be used as floating bearing arrangements, thereby opening up the possibility of reducing machinery size, weight and manufacturing costs due to their ability to simultaneously compensate for both misalignments and axial displacements in the bearing. It is also possible to precisely adjust the radial bearing clearance by axially displacing the two bearing rings relative to each other.

Toroidal rolling bearings can make possible smaller and lighter bearing arrangements with the same or higher performance, for example in planetary gear transmissions. Bearing arrangements for long shafts, which must compensate for temperature-related changes in length, can also be designed in a more simple manner. Toroidal roller bearings are single-row bearings with long, slightly convex rollers. The raceways in the inner and outer rings are concave and are centered at the center of the bearing. The optimally-matched raceway profiles ensure an advantageous stress distribution in the bearing and low-friction operation.

The roller elements of the toroidal bearing can have self-adjusting properties, i.e. they will always adopt the position where the load is evenly distributed over the roller length, irrespective of whether the inner ring is axially displaced and/or misaligned relative to the outer ring.

The load carrying capacity of these roller bearings can be very high, even when misalignments or axial displacements must be compensated. Operationally reliable bearings having a long service life are the result.

However, the mounting of these bearings in their intended applications can sometimes be problematic, especially in larger embodiments. For example, bearings having a diameter of more than 1000 mm, e.g. 1500 mm, are employed in wind turbines. The bearings are mounted on a drive shaft having a correspondingly large diameter and weight. For example, in the case of a vertical mounting (i.e. a vertically-extending rotational axis), the bearings are placed and mounted on the vertically-extending shaft using a crane or gripper. To perform the mounting, the bearing is typically held at the bearing rings by the gripper or crane and the rolling elements are not supported. Consequently, due to gravity, the rolling elements and the bearing cage holding the rolling elements can slip in the axial direction of the bearing relative to the inner and outer bearing rings, which can cause damage to the raceways and/or rolling elements.

In case of vertical mounting a CARB bearing, the roller set can be lowered until the clearance is eliminated, which can lead to twisting or indentations in the raceways or in the surfaces of the rolling elements. To prevent such damage, mounting aids or mounting safeguards have been used in the past. Without such mounting safeguards, one of the bearing rings could for example move so far relative to the bearing cage, or vice versa, that the above-mentioned parts are damaged. Therefore, such mounting safeguards have been used to limit the freedom of movement of the bearing cage, so that movements are only possible in a noncritical range. For example, a pair of plate-shaped brackets that enclose the respective axial ends of the bearing rings has been used. The plates are mechanically connected to each other, for example with bars, bolts, struts, etc. that are passed through the empty spaces between the rolling elements in the bearing.

While this concept reliably restricts the movement of the bearing cage in the axial direction of the bearing, it is disadvantageous, because it is necessary to inset the struts for connecting the plates into and through the gaps between the rolling elements, which can cause damage to the raceways or to the rolling elements during mounting or dismounting of the bearing securing/protecting device. Moreover, the installation cost is very high, since the mounting/dismounting of the struts for connecting the plates must be performed very carefully in order to prevent damage to the above-mentioned parts.

### SUMMARY

It is therefore an object of the present teachings to provide an improved concept for securing and protecting a rolling-element bearing during its installation or mounting at its intended application.

In one aspect of the present teachings, a bearing can be secured and protected during mounting or installation by fixing the bearing cage relative to the bearing rings. If the bearing cage, and thus also the rolling elements, are fixed relative to the bearing rings, a safe mounting can take place without the risk of displacing the bearing cage with the rolling elements relative to the bearing rings during the mounting or installation process.

In another aspect of the present teachings, a method and clamping device for securing and protecting a rolling-element bearing during a bearing mounting operation are disclosed. The rolling element bearing includes a bearing outer ring, a bearing inner ring, a bearing cage and rolling elements. The clamping device includes a clasp or fastener configured to detachably attach to an axial projection of the bearing cage. Ends of the clamping device radially extend over the bearing inner ring and bearing outer ring, respectively, so as to axially support the bearing cage relative to the bearing outer ring and the bearing inner ring when the bearing is lifted with its rotational axis extending vertically.

In another aspect of the present teachings, the clamping device may be mounted on only one axial side of the bearing. The clamping device can be configured to hold or retain the bearing cage, along with the rolling elements disposed therein, as well as the bearing rings in position relative to one another (i.e. without relative movement therebetween), even if there is an extreme lack of space and poor accessibility.

In another aspect of the present teachings, the clamping device preferably eliminates the need for any components that must guided (inserted) through spaces or gaps between the rolling elements, thereby significantly reducing the risk of damage to the raceways and the rolling elements. As a result, disadvantages of the above-described known two-sided clamping device, which includes components that must necessarily be guided through the bearing interior, can be overcome.

In one exemplary embodiment of the present teachings, the clamping device may preferably comprise an attachment means for attaching the clamping device to the bearing cage such that the clamping device axially supports the bearing cage on the bearing inner ring and/or bearing outer ring. For example, the clamping device may be configured to radial overlap the inner bearing ring and/or with the outer bearing ring when the clamping device is attached to the bearing cage.

Expressed in other words, the clamping device preferably comprises attachment means for attaching or fastening the clamping device to the bearing cage. In addition, the clamping device is preferably configured to support the bearing cage by extending over (and being supported by) the bearing rings in the radial direction of the bearing. In such embodiments, the bearing cage is prevented from moving or slipping downward relative to the bearing rings due to gravity, when the bearing is lifted with its rotational axis extending vertically.

In one practical example, in which, e.g., the bearing outer ring of a bearing is held by a crane or gripper in order to install the bearing on a vertically-extending rotatable shaft, the clamping device can be attached to the bearing such that the bearing cage does not move relative to the outer ring. Since the clamping device is fastened to the bearing cage, it radially overlaps the bearing outer ring such that the clamping device contacts and/or rests on the bearing outer ring. In addition or in the alternative, the clamping device may radially extend over the bearing inner ring so that the clamping device contacts and/or rests on the bearing inner ring.

In one exemplary embodiment of the present teachings, the attachment means can be embodied as openable clasp or sleeve defining a bore for receiving a bolt or screw attached to the bearing cage. The clasp or sleeve is configured to surround the body of the bolt or screw and the bore has a diameter smaller than the diameter of the bolt head or screw head.

However, a wide variety of attachment means may be utilized with the present teachings, such as for example a latching mechanism that is releasably fastenable to a corresponding latching hook attached to the bearing cage.

Accordingly, the bearing cage may include a retaining means, such as e.g., the above-noted bolt, screw or latch hook, which is configured to releasably or detachably attach or fasten to the attaching means. The retaining means is preferably configured to support the bearing cage and the rolling elements held by it relative to the bearing inner ring of the rolling element bearing and/or the bearing outer ring of the roller-element bearing. The retaining means can include, e.g., a bore having a retaining bolt or retaining screw fastened in the bore. Other exemplary embodiments are conceivable here too, such as for example all of the structural characteristics or properties that a latching mechanism of a latch hook enables, or a latch hook itself.

In further exemplary embodiments of the present teachings, the clamping device may further comprise an alignment means, by which the position of a bearing cage attached to the device is adjustable relative to the bearing outer ring and/or relative the bearing inner ring. The alignment means may include one or more set screws or spacers, which are configured to facilitate a precise adjustment of the spacing between the clamping device and the bearing rings. Therefore, the position of the bearing cage relative to the bearing rings also can be set or predetermined by appropriate adjusting the alignment means or clamping means.

In a preferred embodiment, the alignment means may comprise one or more screws or bolts configured to adjust the spacing of the clamping device relative to a bearing inner ring or bearing outer ring.

In another exemplary embodiment, the clamping device may comprise first and second parts pivotably coupled together at one end by a hinge, so that they are able to move relative to each other in a folding manner. The two parts preferably define a bore or opening in the closed or folded state. The bore surrounds the corresponding retaining means axially projecting from the bearing cage, such as a bolt- or screw head, when the clamping device is in its closed, folded or clamped state. The clamping device may further comprise a locking or latching means, by which the clamping device can be locked in the closed state. The locking means may comprise, e.g., a screw, a latch, a hook, a locking pin, etc., by which the ends of the two parts, which are opposite of the hinge, may be releasably locked together while the clamp-like clamping device is disposed in the closed state. The locking means may be integrated with the aligning means in certain embodiments.

In further exemplary embodiments, the clamping device may be advantageously utilized to secure and/or protect a toroidal, spherical, and/or barrel rolling bearing during a mounting or installation operation, but in principle other types of rolling-element bearings also may be secured and protected using the present teachings.

In another aspect of the present teachings, a method for securing and protecting a rolling-element bearing during a mounting or installation operation is disclosed, wherein the rolling-element bearing comprises a bearing outer ring, a bearing inner ring, a bearing cage and a plurality of rolling elements. The method comprises attaching a clamping device to the bearing cage and then axially supporting the bearing cage on the bearing inner ring and/or the bearing inner ring of the rolling-element bearing using the clamping device.

Further objects, embodiments, designs and embodiments of the present teachings will be apparent after reviewing the following detailed description and appended claims in view of the drawings.

### BRIEF DESCRIPTION OF THE DRAWINGS

FIG. 1 shows an exemplary embodiment of a device for securing and protecting a rolling-element bearing and a bearing cage.

FIG. 2 shows the exemplary embodiment in perspective view.

FIG. 3 shows a radial cross-section through the exemplary embodiment and the rolling-element bearing when the exemplary embodiment is secured to the bearing cage.

FIG. 4 shows the exemplary embodiment in another representation.

FIGS. 5a to 5d show different views of the exemplary embodiment with dimensions of certain features.

FIG. 6a shows a view similar to FIG. 3 with dimensions of certain features shown.

FIG. 6b shows another perspective view of the exemplary embodiment.

### DETAILED DESCRIPTION OF THE INVENTION

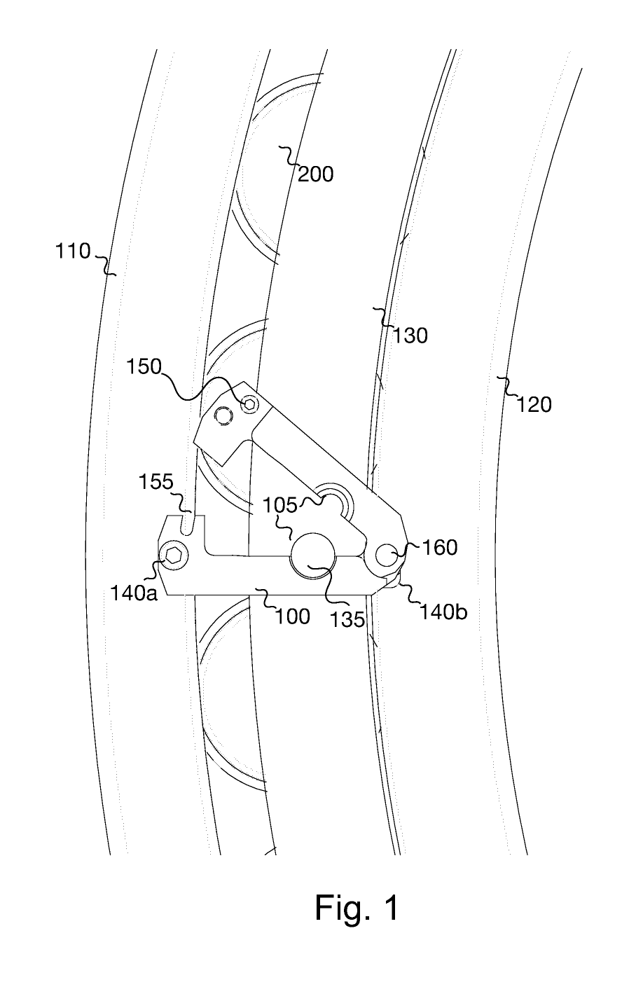

FIG. 1 shows an exemplary embodiment of a device 100 for securing and protecting a rolling-element bearing during a mounting or installation operation. More particularly, FIG. 1 shows a section of a rolling-element bearing having a bearing outer ring 110, a bearing inner ring 120 and a bearing cage 130. FIG. 1 further shows rolling elements 200, wherein for the sake of clarity, only one rolling element is provided with a reference number. In the exemplary embodiment of FIG. 1, the device 100 can be detachably fastened or clamped to the bearing cage 130.

For this purpose, the exemplary device 100 comprises an attachment means 105 for the bearing cage 130. The attachment means 105 is implemented a clasp or clamp defining an opening or a bore, e.g., a circular aperture. In other words, the device 100 may include an opening designed to surround a body of a bolt, screw, etc. The bolt or screw, which is referred to below as retaining means 135 for the bearing cage 130, is also indicated in FIG. 1. The attachment means 105 is configured to surround the retaining means 135 extending from the bearing cage 130, in order to axially support the bearing cage 130, which is connected to the device 100, on the bearing outer ring 110 and/or the bearing inner ring 120. Accordingly, the attachment means 105 may be formed with an opening to receive a bolt 135 or a screw 135 attached to the bearing cage 130.

As can be seen from FIG. 1, the exemplary device 100 is implemented as a clamping device 100. A hinge 160 is located on the right side, by which the two-part device can be opened and closed by pivoting about the hinge 160. On the opposite side, in FIG. 1 on the left side, locking means 150, 155 are located and are configured to releasably fasten or lock the device 100 in its closed state. As will be explained in more detail below, the device 100 further comprises alignment means 140a, 140b, by which the spacing between the device 100 and the respective bearing rings 110, 120 can be set, and/or with the help of which, the device 100 attached to the bearing cage 130 via the retaining means 135 can be positioned relative to the bearing outer ring 110 and/or the bearing inner ring 120.

In other words, the device 100 can be embodied as a clamp, which is attachable to the bearing cage 130 and/or to the bolt or screw 135 attached to, and projecting axially from, the bearing cage 130, so that the bearing cage 130 can not axially displace relative to the bearing rings 110, 120, in particular when the bearing is mounted horizontally, i.e. with a substantially vertically-oriented rotational axis.

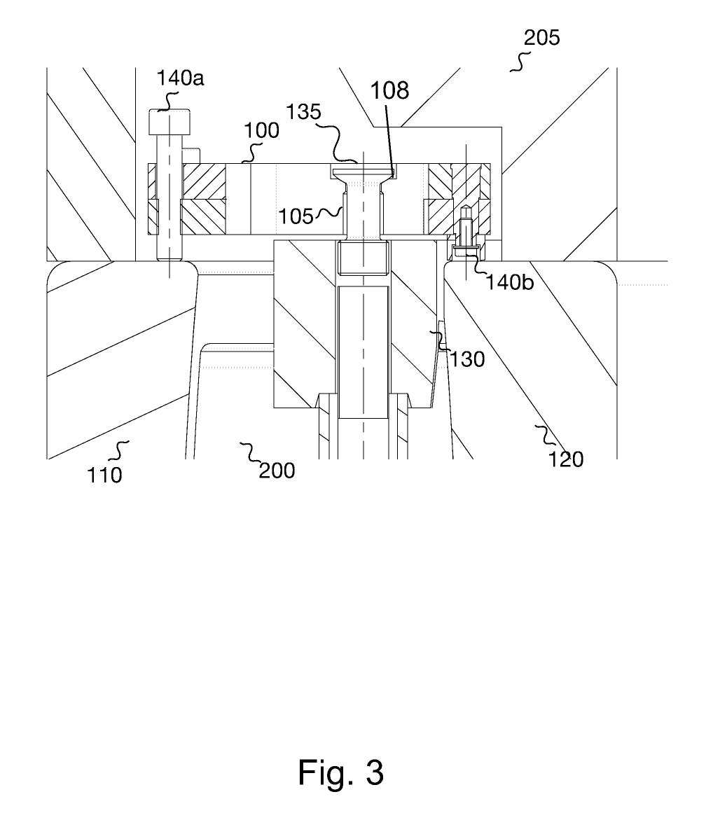

As can be seen in FIGS. 1 and 3, the device 100 is designed to overlap or project over the bearing outer ring 110 and/or the bearing inner ring 120 in the radial direction of the bearing when the device 100 is attached to the bearing cage 130. Therefore, the bearing cage 130 is axially supported (when the bearing is disposed so as to have a vertically-extending rotational axis), because the device 100 rests on the bearing inner ring 120 and/or on the bearing outer ring 110. When the device 100 is clamped onto the retaining means 135, such that the retaining means 135 can not move in the axial direction of the bearing, the bearing cage 130 is held fixed relative to the bearing rings 110, 120.

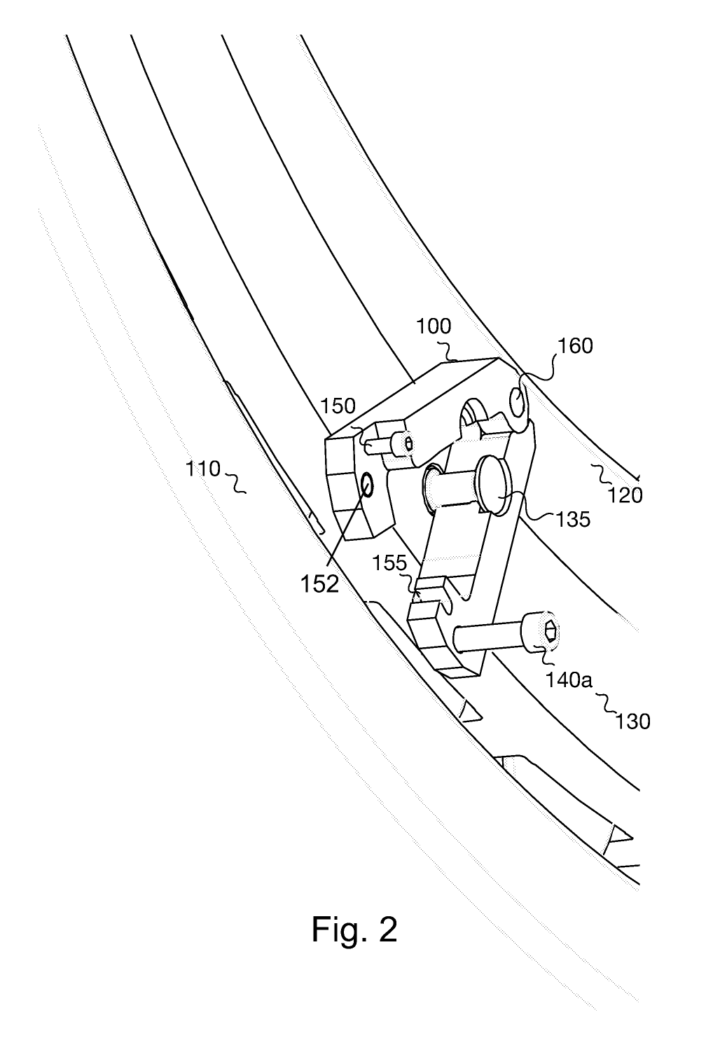

FIG. 2 shows the exemplary embodiment of the device 100 in a three-dimensional or representation, i.e. a perspective view. Because FIG. 2 shows the same components that have already been described with reference to FIG. 1, a repeated description is omitted, and the same components have been denoted with the same reference numbers.

In FIG. 2, the device 100 is shown in its open state with the hinge 160 disposed at a rearward (first) end. The locking means 150, 155 are located on a forward (second) end and include a screw 150 and a groove 155. The locking means of the present teachings are not particularly limited according to the present teachings and various alternate embodiments may be utilized instead of the screw 150 and groove 155. For example, the locking means may include a fastener with a strap, a hook, a clasp, etc. The locking means 150, 155 may be designed to either solely perform the locking function, or as in the present embodiment, the locking means 150, 155 may serve to temporarily hold the device 100 in the closed or clamped state. Then, a screw 140a can be inserted through a hole 152 in order to more permanently lock the device 150 in the clamped or closed state, as will be discussed further below. In certain embodiments, the alignment means 140a and/or 140b (described further below) may perform the function of releasably locking the second ends of the device 100 together.

As will be understood, the device 100 can be embodied as a clamping device 100, which when closed and locked is clampable onto the bearing cage 130, i.e. on the retaining means 135.

Referring to FIGS. 2 and 3, the alignment means 140a, 140b will be described in further detail. The alignment means 140a, 140b enable the position or orientation of the bearing cage 130 attached to the device 100 to be axially adjustable relative to the bearing outer ring 110 and/or relative to the bearing inner ring 120. The alignment means 140a, 140b may comprise the above-noted screw 140a and/or a spacer 140b. In this respect, the alignment means 140a, 140b cooperate with the retaining means 135 and the attachment means 105. In other words, the axial position of the bearing cage 130 relative to the bearing rings 110, 120 depends on the bolt 135 and the attachment means 105, as well as on the screw 140a and the spacer 140b. Furthermore, as was indicated above, the device 100 can be fixed in the clamped state with the attachment means 105 surrounding the bolt 135 by inserting the screw 140a through the hole 152 disposed on the opposite leg of the device 100.

In the present embodiment, a screw 140a can be rotated in its threaded hole to change and thus set the spacing of the device 100 relative to the bearing outer ring 110, as can be seen in FIG. 3. This also determines the position or orientation of the bearing cage 130 relative to the bearing outer ring 110 when the device 100 is clamped onto the retaining means 135.

Generally speaking, the present device 100 can be configured to secure and protect any type of rolling-element bearing. For example, toroidal, spherical roller, or barrel roller bearings may be protected with the device 100.

FIG. 3 shows a radial cross-section through the device 100 of FIGS. 1 and 2 when it has been fastened to the bearing cage 130. FIG. 3 also shows a housing 205 that may be provided to protect the bearing elements. As can be seen in FIG. 3, the opening 105 can be formed as a bore having a diameter that at least partially tapers downwardly, i.e. towards the side of the bearing cage 130. In addition, the opening 105 may include a collar 108, on which the retaining means 135, e.g., the screw head or bolt head, rests when the device 100 has been clamped onto the retaining means 135.

In FIG. 3, the device is shown as being mounted on a horizontally-extending bearing, i.e. the bearing is lying on a flat or level surface with its rotational axis extending vertically. In this state, the bearing rings 110, 120 and the cage 130 can align themselves against each other. When the device 100 is attached to the bearing 130 in this state, the bearing cage 130 can be fixed in position relative to the bearing rings 110, 120 and will not slip downward due to gravity during the bearing mounting process.

The device 100 can be folded closed until the bolt 135 is clamped in the opening 105 and thus the bearing cage 130 is clamped relative to the bearing rings 110, 120. The screw 150 may be tightened in the groove 155 to provisionally fasten the second ends together. Then, the screw 140a may be threaded through the hole 152 and rotate so as to adjust the level of the device 100 in the radial direction of the bearing 100. The screw 140a further serves to lock or connect the second ends of the device 100 together when the device 100 is in the clamped or closed state.

After the entire bearing is lifted, e.g., by one or both the bearing rings 110, 120, with its rotational axis extending vertically, gravity pulls the bearing cage 130 downward with the rolling elements 200 inside and the device 100 is supported on the bearing rings 110 and 120 via the alignment means 140a, b. Generally speaking, the screw 140a will extend downwardly out of the device 100 by the same amount as the spacer 140b, so that the device 100 lies flat, but the screw 140a can be adjusted to compensate for misalignments, if necessary.

In the embodiment of FIG. 3, the device 100 has alignment means 140a, b on both end sides. The spacer 140b can be adapted to the structure of the bearing inner ring 120; for example, the spacer may have a circular surface that allows a flat and level contact on the bearing ring 120. The spacer 140b can be rotatably attached by a screw, so that it can be adapted to the corresponding bearing ring by turning it. Thus, for example a matching of the height and/or a matching of the inclination of the overlapping surface can be achieved.

As shown in FIG. 3, the spacer 140b is attached to the device 100 with a screw, in order to ensure a predetermined spacing between the device 100 and the bearing inner ring 120. In other exemplary embodiments, screws or spacers can of course also be provided on both sides. In one exemplary embodiment, it is possible to use two screws to set the spacing of the device 100 relative to both the bearing outer ring 110 and the bearing inner ring 120. This would correspond to a configuration, which has a screw 140a, as shown on the left side of the device 100 in FIG. 3, on both sides.

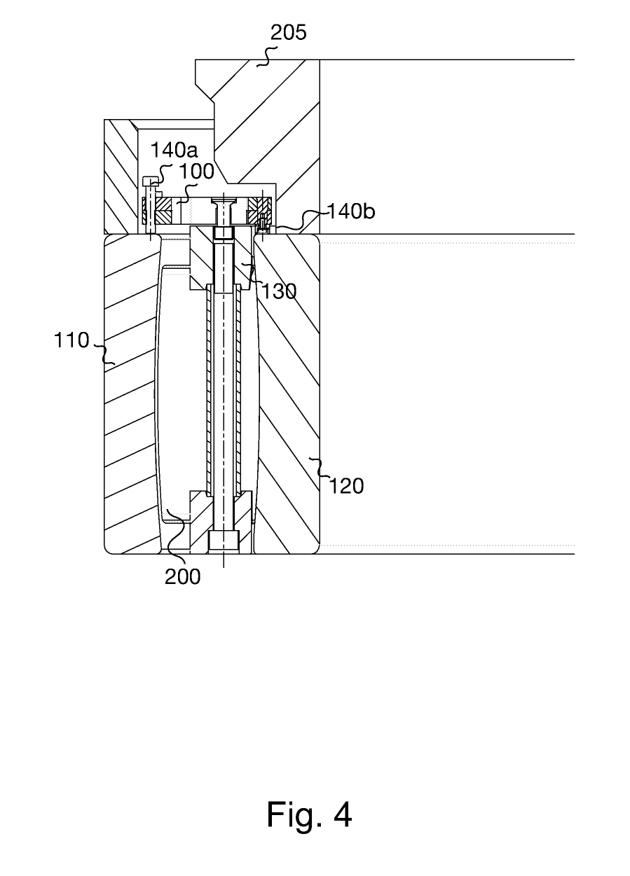

FIG. 4 illustrates the device 100 in a different representation, in which the full axial length of the rolling-element bearing is shown. FIG. 4 depicts, in particular, the extreme lack of space that may be available when installing the bearing in a housing 205. It can also be seen in FIG. 4 that the position of the bearing cage 130 and thus indirectly the position of the rolling elements 200 can be set by the alignment means 140b, and that these can hold the positions of the components of the bearing during the mounting of the bearing.

FIG. 4 also shows that the device 100 can be removed cost-effectively after mounting, despite the severe lack of space. Because the exemplary embodiment of the device 100 is only mounted on one side of the bearing cage 130, it can be simply removed by opening it and thus by a simple release of the attachment between the device 100 and the bearing cage 130. Especially when compared to conventional concepts, which have one or more struts (e.g., a threaded rod) that pass(es) through the space(s) between the rolling elements 200 for connecting plates disposed on both the upper side and the lower side of the bearing, considerable advantages can be achieved with the present teachings, since no components must be removed from the space between the rolling elements 200 after the bearing has been mounted. Thus, the risk of damaging the bearing during the mounting operation can be significantly reduced, especially in wind power plants. Moreover, the mounting process can be expedited, because the device 100 can be removed quickly and simply after the mounted has been concluded and the bearing has been brought into its operating position.

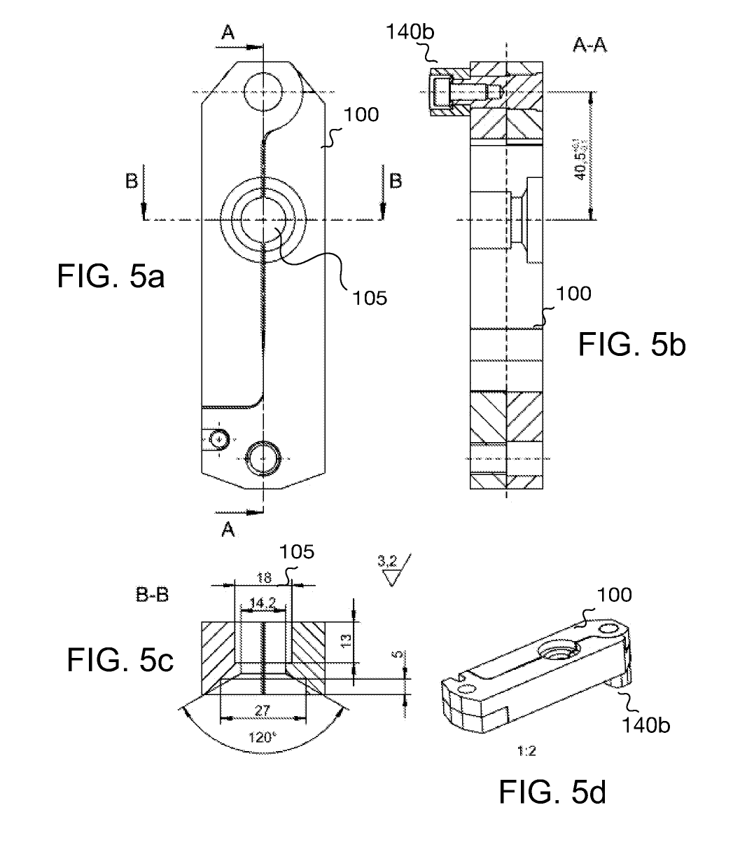

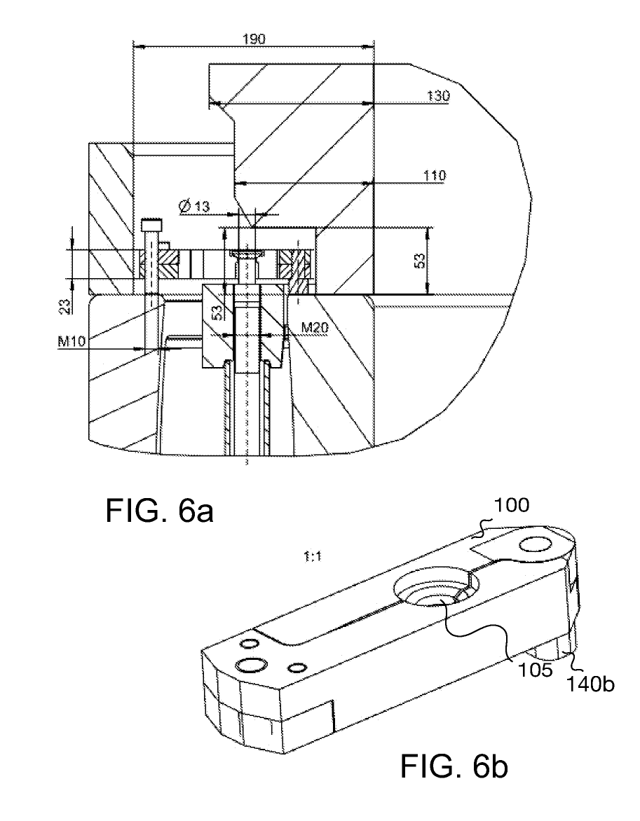

FIGS. 5 and 6 illustrate the exemplary embodiment of the device 100 as a clamping device with some specific dimensions included. For the sake of clarity, a repetition of some of the reference numbers has been omitted. The dimensions of FIGS. 5 and 6 are given in millimeters. The device 100 may be made of metal or plastic.

FIG. 5a shows a top view of the device. FIG. 5b shows the cross-section along line A-A in FIG. 5a and FIG. 5c shows the cross-section along line B-B in FIG. 5a. FIG. 5d shows a perspective view of the device 100 in its clamped state when not mounted on the bearing cage 130.

FIG. 5c shows, in particular, a cross section through the opening or bore 105. The bore may be chamfered, which can improve the clamping function with a correspondingly-formed retaining means or bolt 135.

FIG. 6a shows the device 100 secured to the bearing cage 130 with various dimensions shown and FIG. 6b shows an enlarged perspective view of the device 100.

A representative method for securing and protecting a rolling-element bearing during a mounting operation will now be described. The rolling-element bearing may comprise a bearing outer ring, a bearing inner ring, a bearing cage and a plurality of bearing elements. The method may include attaching the device to the bearing cage and supporting the bearing cage on the bearing inner ring and/or the bearing outer ring of the rolling-element bearing using the device.

In another exemplary embodiment, a mounting method for a rolling-element bearing is disclosed, wherein the bearing is first secured and protected as described above and then is brought into a vertical position with a crane or a gripper. The term “vertical position” is understood herein to mean that the bearing can be mounted on a drive shaft oriented with its rotational axis substantially in the vertical direction.

In another exemplary embodiment, the bearing can also be secured in a vertical position, for example it could be laid on a flat surface so that the bearing rings and the cage are oriented against each other. Attaching the device in this position is also possible. Afterwards, the secured bearing can be raised and mounted. After the mounting, the drive shaft, and with it the bearing, is brought back again into the horizontal position (i.e. in a position in which the rotational axis of the drive shaft is substantially horizontal) and the device is removed.

### REFERENCE NUMBER LIST

100 clamping device
105 attachment means
110 bearing outer ring
120 bearing inner ring
130 bearing cage
135 retaining means
140a, b alignment means
150 locking screw
152 hole
155 locking groove
160 hinge
200 rolling elements
205 housing

1. A clamping device configured to secure and protect a rolling-element bearing during a bearing mounting operation, wherein the rolling-element bearing comprises a bearing outer ring, a bearing inner ring, a bearing cage disposed between the bearing outer and inner rings and a retaining means axially projecting from the bearing cage, the clamping device comprising:
a first part having a first end and a second end,
a second part having a first end and a second end, the first end of the first part being pivotably coupled to the first end of the second part via a hinge,
the second end of the first and second parts having each having locking means for releasably locking the clamping device in its closed position,
an attachment means defined by the first and second parts between the first and second ends thereof, the attachment means being configured to surround and clasp at least a portion of the retaining means when the clamping device is folded into its closed position,
wherein one of the first and second ends of the first and second parts is configured to radially overlap and rest on the bearing inner ring and the other of the first and second ends of the first and second parts is configured to radially overlap and rest on the bearing outer ring so as to axially support the bearing cage relative to the bearing outer ring and the bearing inner ring when the clamping device is clamped onto the retaining means.

2. The device according to claim 1, further comprising alignment means for adjusting the position of the bearing cage attached to the clamping device relative to the bearing outer ring and/or relative to the bearing inner ring.

3. The device according to claim 2, wherein the alignment means comprises at least one screw configured to adjust a distance between the clamping device and one of the bearing inner ring and the bearing outer ring.

4. The device according to claim 3, wherein the at least one screw extends through the second ends of the first and second parts and locks the clamping device in its closed position.

5. The device according to claim 4, wherein:
the retaining means comprises a screw or a bolt having a body and a head,
the attachment means defines a bore, a portion of which has at least substantially the same cross-section as the body of the screw or bolt and
the bore includes a collar having a diameter smaller than a diameter of the head of the screw or bolt.

6. The device according to claim 5, wherein the bore is at least partially tapered.

7. The device according to claim 5, further comprising a spacer disposed on the first end of at least one of the first and second parts, the spacer being con1d to rest on the bearing inner ring.

8. The device according to claim 7, wherein the spacer is connected to the first end of at least one of the first and second parts by an adjustable screw.

9. The device according to claim 8, wherein the locking means comprises:
an adjustable screw disposed on the second end of the first part and
a groove defined in the second end of the second part, the groove being sized to receive the adjustable screw.

10. A method for securing and protecting a rolling-element bearing during a bearing mounting operation using the clamping device of claim 1, wherein the rolling-element bearing comprises a bearing outer ring, a bearing inner ring, a bearing cage disposed between the bearing outer and inner rings and a retaining means axially projecting from the bearing cage, the method comprising:
clamping the retaining means within the attachment means of the clamping device of claim 1 by pivoting the first part of the clamping device relative to the second part of the clamping device or vice versa,
locking the second end of the first part to the second end of the second part,
supporting the first ends of the first and second parts on one of the bearing inner ring and bearing outer ring while supporting the second ends of the first and second parts on the other of the bearing inner ring and the bearing outer ring, wherein the bearing cage is supported relative to the bearing inner ring and bearing outer ring in an axial direction of the rolling-element bearing.

11. The method of claim 10, further comprising:
lifting the rolling-element bearing with the axial direction of the bearing element extending vertically.

12. The method of claim 11, further comprising:
adjusting a distance between at least one of the first and second ends of the clamping device and at least one of the bearing outer ring and the bearing inner ring.

13. The method of claim 12, wherein the adjusting step is performed by rotating an adjustable screw that extends through one of the first and second ends of the clamping device and rests on the bearing outer ring or the bearing inner ring.

14. A method for securing and protecting a rolling-element bearing during a bearing mounting operation using the clamping device of claim 9, wherein the rolling-element bearing comprises a bearing outer ring, a bearing inner ring, a bearing cage disposed between the bearing outer and inner rings and a retaining means axially projecting from the bearing cage, the method comprising:
clamping the retaining means within the attachment means of the clamping device of claim 9 by pivoting the first part of the clamping device relative to the second part of the clamping device or vice versa,
locking the second end of the first part to the second end of the second part,
supporting the first ends of the first and second parts on one of the bearing inner ring and bearing outer ring while supporting the second ends of the first and second parts on the other of the bearing inner ring and the bearing outer ring, wherein the bearing cage is supported relative to the bearing inner ring and bearing outer ring in an axial direction of the rolling-element bearing.

15. The method of claim 14, further comprising:
lifting the rolling-element bearing with the axial direction of the bearing element extending vertically.

16. The method of claim 15, further comprising:
adjusting a distance between at least one of the first and second ends of the clamping device and at least one of the bearing outer ring and the bearing inner ring by rotating the at least one screw of the alignment means.

17. The method of claim 16, wherein the rolling-element bearing comprises one of toroidal, barrel, and spherical rolling elements.

18. The method of claim 13, wherein the rolling-element bearing comprises one of toroidal, barrel, and spherical rolling elements.
